(19) United States
(12) Patent Application Publication
(10) Pub. No.: US 2007/0259319 A1
(43) Pub. Date: Nov. 8, 2007

(54) SYSTEM AND METHOD FOR CONTROLLING BEHAVIOUR

(76) Inventors: Rex Stock, Reno, NV (US); Daniel Dugan, Reno, NV (US); Peter Wolfgang DeRaedt, Reno, NV (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/735,094

(22) Filed: Apr. 13, 2007

Related U.S. Application Data
(60) Provisional application No. 60/744,768, filed on Apr. 13, 2006.
(60) Provisional application No. 60/823,450, filed on Aug. 24, 2006.
(60) Provisional application No. 60/865,561, filed on Nov. 13, 2006.

(51) Int. Cl. G09B 19/00

(52) U.S. Cl. 434/236; 434/327; 434/365

(57) ABSTRACT

A system and method changes the behavior of a user with respect to an activity. The system and method automatically detects the performance of the activity by the user and automatically performs an interruption process, such as displaying a representation of the user stopping the activity.

### RELATED APPLICATIONS

The present applications claims priority to U.S. Provisional Patent Application Ser. No. 60/744,768, filed Apr. 13, 2006; U.S. Provisional Patent Application Ser. No. 60/823,450, filed, Aug. 24, 2006; and U.S. Provisional Patent Application Ser. No. 60/865,561, filed, Nov. 13, 2006, all of which are hereby incorporated by reference.

### TECHNICAL FIELD

The present invention relates generally to behavior modification and most specifically to a system and method to assist a user with changing their behaviour.

### BACKGROUND OF THE INVENTION

Habitual behavior (frequent, repetitive behavior) can become self-destructive in the way they interfere with other life responsibilities (i.e., gambling instead of spending time with family) and/or in how they change physical functioning (i.e., alcohol or cigarette use). Indeed, at some point, a habit can cross the line to an addiction. Addictions, by some definitions, are habit behaviors that consume great amounts of time and resources. Self-destructive behaviors include, but are not limited to, substance use, smoking, eating disorders, gambling, shopping, etc. . . .

When done in moderation, most habits will not become self-destructive. We all need to eat, yet, over- or under-eating can have dire health consequences. Alcohol use might be the same: most people can control their consumption at a recreational level without hurting their bodies, injuring others, or destroying relationships. So, a behavior at one frequency might be relatively harmless, while increasing the frequency of that same behavior could be destructive. One does not need to “hit bottom” to learn to control habits. The desire to control a potentially self-destructive behavior before it reaches the level of an addiction or compulsion and knowing how to control that behavior is the key to successful maintenance of a behavior.

For example, wagering on various games, i.e., “gaming” or gambling is increasing rapidly. Along with the increase in gaming, the number of “problem” gamers, is also rapidly increasing. Problem gaming poses some challenges for people with the problem and for those trying to help them:

1. True gambling addicts have distorted thoughts about their play. They firmly believe that the next pull will relieve them of the all their debts because they are “due;”

2. Slot machines pay off on a variable ratio schedule, the most powerful reward schedule for maintaining behavior (pulling the handle). Rats who are taught to pull a lever on a variable ration schedule for food will pull until they collapse from exhaustion. Rats on other schedules (i.e., fixed ratios) will quit when the pay-off does not come relatively close to the expected time. Fixed ratio behavior “extinguishes” while variable ratio behavior is very resistant to extinction. The gaming industry knows this and designs its slots in exactly this fashion to maintain pulling;

3. True gambling addicts report a sort of “tunnel vision” when they play. Their visual field is focused in the center and blurs out on the periphery. It is almost like the hyper-focus of an athlete “in the zone.” This makes them unaware of their surroundings or how their play might fit into their total financial picture at the time.

4. True gambling addicts are fairly covert, not wanting to be seen or caught by those who might know they have a problem. They usually gamble alone, change locations, and find times when family or friends will not question their absence.

Because of these factors, problem gambling is hard to treat. Problem gamblers have nobody there to prompt them away, their attention gets hyper-focused, and their distorted beliefs mixed with the variable ratio schedule of pay-outs makes it hard for them to walk away until their money supply is exhausted.

Other types of personal activities (eating, smoking, alcohol use, etc.) which a person may want to change or eliminate are also problematic in that they share similar properties (i.e., irrational thoughts—“one more piece of cake won't hurt me;” being performed covertly—pornography at a workstation; and reinforcement schedules resistant to extinction—“I'll feel better with just this one last cigarette, then I'll quit.”) to the gambling addiction described above. Some habits cross a line when they are performed in order to avoid a negative consequence (i.e., taking a sleep aid to avoid insomnia) and become very difficult to stop.

The present invention is aimed at one or more of the problems identified.

### SUMMARY OF THE INVENTION

In a first aspect of the present invention, a method for changing the behavior of a user with respect to an addictive activity is provided. The method includes the steps of automatically detecting performance of the addictive activity by the user and performing an interruption process in response detecting the performance of the addictive activity.

In a second aspect of the present invention, a system for changing the behavior of a user with respect to an addictive activity is provided. The system includes a controller and a displayer. The controller automatically detects performance of the addictive activity by the user and performs an interruption process, using the display, in response detecting the performance of the addictive activity.

In a third aspect of the present invention, a method for changing the behavior of a user with respect to an addictive activity is provided. The method includes the steps of automatically detecting performance of the addictive activity by the user and displaying, to the user, a representation of a person performing an alternative behavior possibility in response to detecting performance of the addictive activity.

In a fourth aspect of the present invention, a system for changing the behavior of a user with respect to an addictive activity is provided. The system includes a controller and a display. The controller automatically detects performance of the addictive activity by the user and displays on the display a representation of a person performing an alternative behavior possibility in response to detecting performance of the addictive activity.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram of a system for changing the behavior of a user, according to an embodiment of the present invention;

FIG. 2 is a diagrammatic illustration of a cell phone for use with the present invention, according to one embodiment;

FIG. 3 is a diagrammatic illustration of a personal digital assistant for use with the present invention, according to one embodiment;

FIG. 4 is a diagrammatic illustration of a computer for use with the present invention, according to one embodiment;

FIG. 5 is a diagrammatic illustration of a gaming machine for use with the present invention, according to one embodiment;

FIG. 6 is a flow diagram of a method for changing the behavior of a user, according to an embodiment of the present invention; and,

FIG. 7 is a flow diagram of a second method for changing the behavior of a user, according to an embodiment of the present invention.

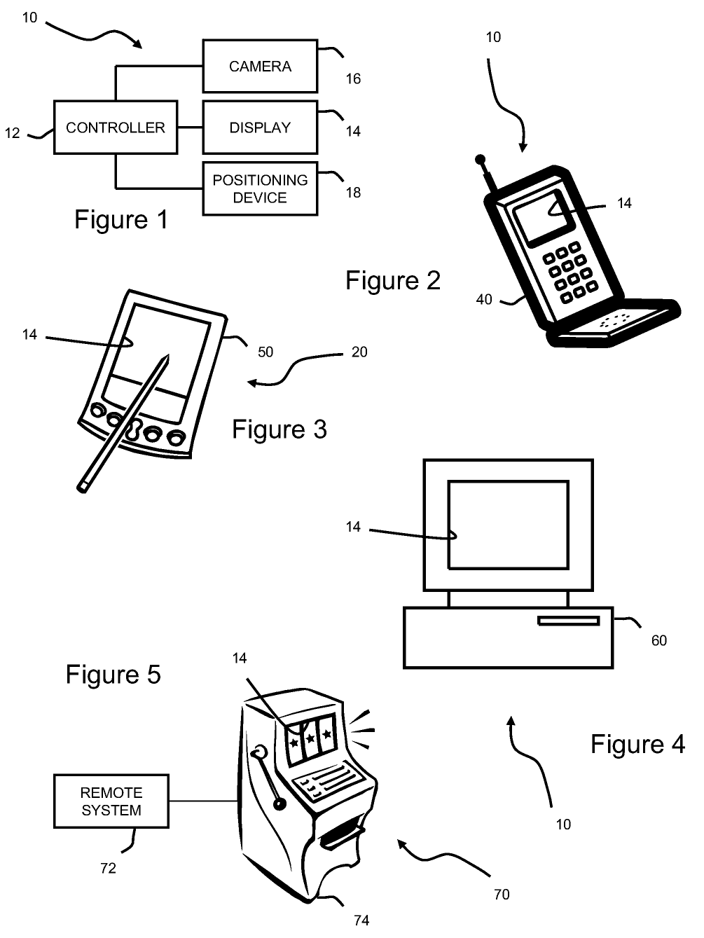

### DETAILED DESCRIPTION OF INVENTION

Referring to the Figures, wherein like numerals indicate like or corresponding parts throughout the several views, a system 10 and methods 80, 90 are provided for changing the behavior of a user with respect to an addictive behavior or any behavior which the user wants to modify or eliminate. In one aspect of the present invention, the system 10 includes a controller 12 and a display 14.

As discussed more fully below, the behavior is any type of behavior, including, but not limited to smoking, drinking alcohol, using illegal drugs, playing games, eating disorders, gambling, watching television, etc. . . . The behavior may also include not performing a specific activity, i.e., procrastinating or any other behavior the user wants to modify or eliminate.

The system 10 may be, at least partially, embodied in a machine 70, such as a slot or video poker machine 74, which allows the user to perform a predetermined activity, i.e., gaming. The system 10 may also be adapted for use with other types of gaming, gaming machines or devices, including table games, lotteries, internet gaming, online gaming etc. . . . Alternatively, the system 10 may be embodied in a remote device 20. The remote device 20, in one embodiment may be carried by the user, e.g., a cell phone 40 or a personal digital assistant 50, media player or the like. In another embodiment, the remote device 20 may be a personal computer or game console 60.

Typically, the controller 12 may be the computer or microprocessor which runs or is associated with the machine 70. For example, in the slot machine 74, the controller 12 may also run the software which plays the game on the slot machine 74. Alternatively, the controller 12 may be associated with a remote system 74 associated with the machine 70, such as an accounting or player tracking system or other suitable associated system. Such systems are well known in the art, and are therefore, not further discussed.

In one aspect of the present invention, the controller 12 automatically detects performance of the activity by the user and performs an interruption process, using the display, in response detecting the performance of the activity. The interruption process may be predetermined or may be modified under programming or artificial intelligence based on user actions, e.g., answers to questions. In one aspect, the interruption process is aimed at encouraging the desired behavior (including stopping the undesirable behavior).

In one embodiment, the user is not allowed to perform the activity (at least temporarily during the interruption process).

In one embodiment, the controller detects initiation of the activity by the user.

Wherein the system 10 is incorporated into a machine 70 which allows the user to perform the behavior, the machine 70 may detect initiation of the activity by the user when the user begins to use the machine 70. In the context of gaming, gaming machines 70, such as slot machines 74 may be linked to a player tracking system 72. The player tracking system 72 typically identifies players through the use of a player tracking card (or other suitable mechanism) (not shown) and tracks the player's play for the purpose of awarding comps or bonus points. In this context, the system 10 may detect initiation of the behavior when the user/player is identified to the player tracking system.

In other embodiments, the system 10 may detect performance or initiation of the activity in other ways, e.g., via location of the user, or other activity and detects occurrence of a predetermined triggering condition associated with performance of the predetermined activity.

In one embodiment, the system 10 may include a positioning device 18, such as a GPS receiver, which establishes a location of the user. The positioning device 18 may be incorporated into the remote device 20. Initiation of the behavior may be detected based on the user being at a specific place or type of place, e.g., a bar or other location where alcoholic drinks are served. The system 10 may also be tied to other remote system 10, such as a credit system, which determines if the user purchases certain items or types of items using their credit card. For example, the system 10 may be notified if the user purchases alcohol (independent of location).

The triggering condition is generally related to the activity. For example, the triggering condition may be the purchase of the alcohol or the entering of a bar.

The triggering condition may alternatively be time based. For example, the triggering condition may be a duration the user has been performing the behavior. The duration may be predetermined. For example, the duration may be set by the system 10 or may set by the user 10 (and stored in a user profile).

The interruption process is generally aimed at preventing the user from continuing the activity and/or delaying the user from continuing the activity and allowing the user to pause and think prior to continuing the activity. The interruption process may include audio (recorded in the user's own voice or someone else's voice) and/or video or other type of graphic or moving pictures. In one embodiment, an avatar, i.e., computer simulation, of the user may be used to interact with the user and may be used to show the user performing some alternative activity,

In one embodiment, the interruption process includes a predetermined delay during which the user cannot or is prohibited from continuing the activity.

In another aspect, the interruption process may also or alternatively includes one or more queries with respect the activity which are presented to the user. In one embodiment, the queries require input from the user in order to continue performance of the activity. The content or form of the interruption may vary and be based on research and the type of activity or behavior which the user wants to modify or eliminate.

For example, if the activity is gambling, the interruption process may include one or more queries with respect to the user's desire or ability to continue gambling. In one embodiment, the controller 12 may establish an amount lost and/or played, i.e., wagered, by the user, providing the user with the amount lost and/or played, and asking the user whether they can afford to lose. A query may also be related to the emotional state of the user, e.g., “How are you feeling?” or may be a direct question of whether the user wants to continue.

In still another aspect of the present invention, the controller 12 displays a representation of a person performing an alternative behavior possibility on the display 14. For example, the alternative behavior possibility may include terminating the activity. In one embodiment, the representation of a person includes a likeness of the user, e.g., either a drawing or picture of the user. In another embodiment, the representation of a person performing an alternative behavior possibility includes the person walking away. The representation of the person may include one or more images and/or animations and/or movies (i.e., the self-modeling video) displayed on the display 14.

In another aspect of the present invention, the system may include a camera 16 for capturing an image of the user. The image may then used in the interruption process, i.e., in an animation, movie, picture or series of pictures. The image may be incorporated into an avatar which, under the control of programming or artificial intelligence, has a conversation with the user.

In one aspect of the present invention, the triggering condition may be based on one or more of the following a current location of the user and/or time. A trigger based on time may include a time limit for performance of the activity. The time limit may be preset, established by the user (and stored in a user profile), and/or randomly determined.

As stated above, the activity may be the playing of a game, either with or without wagering. For a game, the triggering condition may be time based and/or related to a number of plays of the game. Alternatively, (or in combination), the triggering condition (if wager based gaming), may be related to an amount won, lost, or wagered.

In another aspect of the present invention, the controller 12 automatically detects performance of the activity by the user and displays on the display 14 a representation of a person performing an alternative behavior possibility in response to detecting performance of the activity.

In one embodiment, the alternative behavior possibility includes terminating the activity. The representation of a person may include a likeness of the user (or an avatar) and may show or demonstrate the person walking away from the activity or taking alternative steps that alter the behavior.

The alternative behavior possibility may be displayed on the display 14, which may be part of the machine 70 or may be part of a separate device 20.

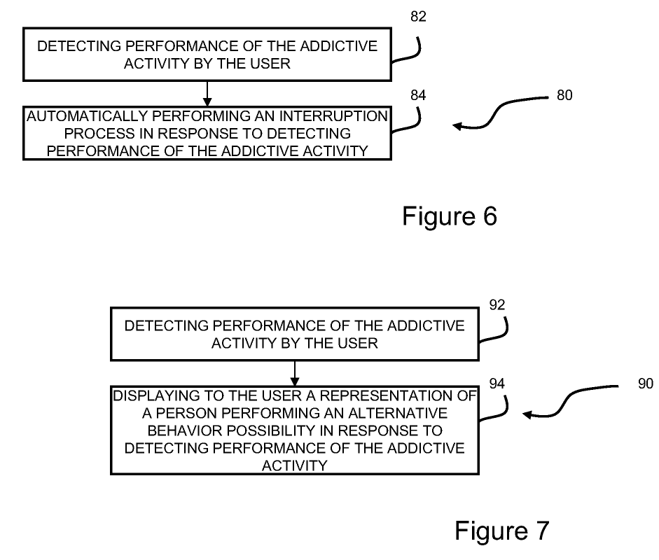

With specific reference to FIG. 6, in another aspect of the present invention a method 80 for changing the behavior of a user with respect to an activity is provided. In a first step 82, performance of the activity by the user is automatically detect. In a second step 84, an interruption process is performed in response detecting the performance of the activity. During the interruption process, the user is not allowed to perform the activity.

With specific reference to FIG. 7, in still another aspect of the present invention a method 90 for changing the behavior of a user with respect to an activity is provided. In a first step 92, performance of the activity by the user is automatically detected. In a second step 94, a representation of a person performing an alternative behavior possibility is displayed to the user, in response to detecting performance of the activity.

In one aspect, the system 10 may be modified by the user. For example, the user may be allowed to modify or define the triggering conditions or parameters which define the triggering condition.

### INDUSTRIAL APPLICABILITY

Application to Problem Gaming

Problem gaming poses some challenges for people with the problem and for those trying to help them:

True gambling addicts have distorted thoughts about their play. They firmly believe that the next pull will relieve them of the all their debts because they are “due;”

1. Slot machines pay off on a variable ratio schedule, the most powerful reward schedule for maintaining behavior (pulling the handle). Rats who are taught to pull a lever on a variable ration schedule for food will pull until they collapse from exhaustion. Rats on other schedules (i.e., fixed ratios) will quit when the pay-off does not come relatively close to the expected time. Fixed ratio behavior “extinguishes” while variable ratio behavior is very resistant to extinction. The gaming industry knows this and designs its slots in exactly this fashion to maintain pulling;

2. True gambling addicts report a sort of “tunnel vision” when they play. Their visual field is focused in the center and blurs out on the periphery. It is almost like the hyper-focus of an athlete “in the zone.” This makes them unaware of their surroundings or how their play might fit into their total financial picture at the time.

3. True gambling addicts are fairly covert, not wanting to be seen or caught by those who might know they have a problem. They usually gamble alone, change locations, and find times when family or friends will not question their absence.

Because of these factors, problem gambling is hard to treat. Problem gamblers have nobody there to prompt them away, their attention gets hyper-focused, and their distorted beliefs mixed with the variable ratio schedule of pay-outs makes it hard for them to walk away until their money supply is exhausted.

Self-modeling may address all of these problems at once:

1. The self-modeling video could break the distorted thoughts by having the gambler answer a few questions before proceeding (i.e., “can you afford to lose more than the $20 you have just lost?” or “Are you having fun right now or are you somewhat nervous-feeling?”);

2. The interruption of the variable ratio schedule might make it easier to leave than to continue to perseverate on pulls;

3. The gamblers attention is focused on the screen, so the screen seems like the most likely place to get a message across to them (rather than a sign on the wall by the slot area that they passed, but did not read);

4. Since they are there by themselves, than the best model for them is to see themselves get up and walk away.

In one scenario the system 10 may operate as follows:

A problem gambler sits down at a seemingly normal slot machine with an electronic screen (i.e., a video poker machine). He puts $20.00 into the slot and begins to play. When those $20 are lost, the machine “freezes” for a moment and an image of the gambler appears on the screen, almost as if he was looking into a mirror rather than into a video screen. A voice comes on that says something like, “You have just lost $20 on this machine. Let me ask you a few questions. First, is this $20 an amount you can afford to lose right now? [A touch screen comes up with a YES and NO box that the player answers] Are you having fun playing, or are you feeling at all nervous? [The touch screen choices come up FUN and NERVOUS] Are you going to be OK with your finances if you continue to play? [Touch screen YES or NO]. If this is not fun for you or if you are feeling uncomfortable, let me show you one thing you can do that might help. [The screen, which has scanned in the image of the person and has integrated that image with a pre-programmed animation, shows the player stand up, walk away from the slot machine, and out the door.] Do you want to continue to play? [Touch screen gives YES and NO options].

If the player says “NO” to the first question, NERVOUS to the second question, or “NO” to the third question, the screen would go right to the video at that point. It would always offer the last question, but if the player wanted to continue playing even answering negatively, then the message would be repeated on a certain schedule sometime later in their play. The subsequent times it comes up, the message might begin with a new sentence, like, “I see you are still here and you have lost a little more than the last break. How about those questions I asked before? [Then repeat the self-modeling sequence] . . . ”

None of this would interrupt play for very long and might be enough to break the chain of repeated pulls in a problem gambler, whereas it might have little to no effect on someone who is truly just gambling for recreation.

The idea is a method utilizing self-modeling and self-control technologies to help people with a gambling problem to try to curb the rate at which they play. This method is based on three different known psychological factors: 1. schedules of reinforcement; 2. self-control; and, 3. modeling.

Slot machines are set to pay off on a variable ratio schedule of reinforcement. This means that a jackpot will hit after an average number of plays by the gambler. A variable ratio schedule of 100, for example, means that sometimes a jackpot hits after 80 pulls and then might not hit again for 120 pulls. Since the gambler never really knows the schedule and has no data on prior players on that same machine, the result is to think that the next play is the one that will hit because the machine is “due.” Thus, variable ratio schedules play into addictive behavior perfectly. Variable ratio schedules are known in the literature as the most powerful schedules for maintaining a previously learned behavior (pulling a slot arm). The current invention is designed to attack this schedule of reinforcement, breaking the chain of behavior that is happening, and allowing the gambler to make a choice about stopping. When the behavior chain is interrupted, then some self-control techniques can be inserted. Rather than blindly continuing to place quarters in a slot machine until all your funds are gone, a gambler could be taught to answer some simple questions (i.e., can I afford this? Is this fun?). Self-control questions raise the gambler's awareness of what they are doing and reminds them to pay attention to the consequences of continuing versus stopping. Finally, modeling (showing someone how to do something) has been known to be an effective teaching tool for thousands of years. Self-modeling, where people actually sees themselves performing a behavior, has been shown to be an even stronger teaching tool. For instance, a child has trouble playing with other kids on a playground. That child is video-taped from behind merely standing there while others play in the background. By editing the video and shortening the distance between the child standing and those playing, the tape can make it appear that the standing child is actually in the game that the others are playing! Then, by showing that altered tape to the shy child later, he starts to join in the actual play on subsequent recesses. In subjective terms, the child might be thinking “well, I saw myself playing with them yesterday, so I must be able to do it.” This invention would use the same techniques in that the person's image is captured and played back to them as a model for an alternative behavior.

That's the addiction part and it's, so that schedule plays into people's addictions just perfectly. And it's the most powerful learning schedule of payoffs known in psychology. And so one of the first principles of this device that we are creating is to break that chain somewhere in the chain of person engaging their behavior trying to break it so that they can at least have a choice about stopping their behavior at some point. The second psychological principle is the principle modeling. It's well known that one of the best ways to teach a behavior is to show someone that, how to engage in the behavior that you want them to engage in, so you model it for them. And if you look at even literature all the way down to kids with developmental problems showing them the behavior that you want them to engage in is a very powerful way to teach them. To take that one step further, there is some research that has been termed “self modeling,” where the person who is the subject of the treatment program is actually videotaped, and the videotape is manipulated to show them on a replay of the subject engaging in the behavior that you want to see them do, even if the subject hadn't been doing that. For instance, a kid who doesn't play with other kids on the playground can be videotaped on certain angles and the tape can actually even be manipulated to shorten distance between the kid and the other people playing in a game that when the tape is played back to the child, the child actually looks like they're engaged in the game and then there's some commentary going along with them saying, praising them while they're watching the tape, saying look, you're playing with the other kids, that's really good, we really like to see you do that. So this device would play on that research of self-modeling.

As discussed above, the system 10 may include a camera 16, e.g., mounted in or on the slot machine 74. When a person comes up to play, an image or video of the person will be captured and pasted onto an animation of a person sitting at a slot machine who stands up and walks away from the slot machine and walks off the floor. There are also several other ways we could get the image or video of the person into the system 10, e.g., an image taken at a kiosk or sign-up booth or stored in a player tracking system.

In one implementation, the player could end up seeing an image of themselves standing up and walking away from the machine. And this would come up either on a separate video screen that would be mounted on the slot machine 74 or on the display 14 of the slot machine 74 or any associated display.

The display 14 may incorporate a touch screen sensor or utilize existing buttons which may be used by the player to answer any queries.

Sample queries may include:

“Are you having fun doing what you're doing right now?”

“Can you afford to be playing this game right now”

Or similar types of questions, which may require a (yes or no) answer before continuing.

In another embodiment, the player may establish their limit before they start playing. For example, let's say the player sits down to start playing, and inserts their player tracking card into the machine 70, the machine 70 asks them what's their limit for play that day and they enter $100. At some point as they approach that $100 or when they hit the $100, the system 10 would trigger the queries or questions and then either based on their answer(s) or independent of their answer possibly if they're close to their limit, the self-modeling video would give them an alternative. For example, the self modeling video could represent the player saying “if you're not having fun right now, let us show you something that you can do as an alternative” (or something similar). The video would then play and the person would see themselves getting up and walking away from the machine.

In an alternative embodiment, the machine 70 may lock up when the player at that is at the limit and the alternative behavior is being shown. Alternatively, the machine 70 may lock out the player for a predetermined period of time. The player may be locked out on that game, in the specific casino and/or related casinos over the predetermined period.

In another aspect, the system 10 may provide an incentive to the player to quit. For example, if the system 10 is loss based, the system 10 interruption process could offer the player a percentage of their loss back, a comp (such as a free meal), or other predetermined award or incentive, to walk away.

Weight Loss, Smoking or Alcohol

If a person or user is on a diet, the person could register a food list with a grocery store or (fast food) restaurant and place limits or identify certain types of food products. The system 10 could be notified if the person then enters a specific restaurant or type of restaurant or purchases certain types of food, and then attempt to contact the person through their cell phone 40, PDA 50 or other device and proceed with the interruption process. The system 10 and methods 80, 90 could be similarly tied to alcohol and cigarettes.

Many modifications and variations of the present invention are possible in light of the above teachings. The invention may be practiced otherwise than as specifically described within the scope of the appended claims.

What is claimed is:

1. A method for changing the behavior of a user with respect to an activity, comprising:
automatically detecting performance of the activity by the user; and,
performing an interruption process in response detecting the performance of the activity, the user not being allowed to perform the activity at least temporarily during the interruption process.

2. A method, as set forth in claim 1, wherein the step of detecting performance of the activity, includes the steps of:
detecting initiation of the activity by the user; and
detecting occurrence of a predetermined triggering condition associated with performance of the predetermined activity.

3. A method, as set forth in claim 1, wherein the interruption process includes one or more queries with respect the activity.

4. A method, as set forth in claim 3, wherein the queries require input from the user in order to continue performance of the activity.

5. A method, as set forth in claim 1, wherein the step of performing an interruption process includes the step of displaying a representation of a person performing an alternative behavior possibility.

6. A method, as set forth in claim 5, wherein the alternative behavior possibility includes terminating the activity.

7. A method, as set forth in claim 5, wherein the representation of a person includes a likeness of the user and/or other individual known to the user.

8. A method, as set forth in claim 5, wherein the representation of a person performing an alternative behavior possibility includes the person walking away.

9. A method, as set forth in claim 1, wherein the activity is performed on a machine and the interruption process includes displaying one or more images and/or animations and/or movies on a display.

10. A method, as set forth in claim 9, wherein the display is associated with the machine.

11. A method, as set forth in claim 10, wherein the display is associated with a device remote from the machine.

12. A method, as set forth in claim 11, wherein the device remote from the machine is one of a cell phone, personal digital assistant, media player, or other suitable device.

13. A method, as set forth in claim 1, wherein the interruption process includes a predetermined time delay during which the user cannot perform the activity.

14. A method, as set forth in claim 1, wherein the activity is gambling and the interruption process includes one or more queries with respect to the user's desire or ability to continue gambling.

15. A method, as set forth in claim 14, including the step of establishing an amount lost and/or played by the user, providing the user with the amount lost and/or played, and asking the user whether they can afford to lose.

16. A method, as set forth in claim 14, wherein at least one query is related to an emotional state of the user.

17. A method, as set forth in claim 14, wherein at least one query asks the user if the user wants to continue.

18. A method, as set forth in claim 1, including the step of capturing an image of the user using a camera, wherein the image is used in the interruption process.

19. A method, as set forth in claim 2, including the step of creating a user profile associated with the user, the triggering condition being defined by and/or based on the user profile.

20. A method, as set forth in claim 2, including the step of establishing a current location of the user, wherein the triggering condition is a function of the current location.

21. A method, as set forth in claim 2, wherein the triggering condition is time based.

22. A method, as set forth in claim 2, wherein the triggering condition is a time limit.

23. A method, as set forth in claim 22, wherein the time limit is established by the user.

24. A method, as set forth in claim 22, wherein the time limit is randomly determined.

25. A method, as set forth in claim 2, wherein the activity is the playing of a game, the triggering condition being related to a number of plays of the game.

26. A method, as set forth in claim 2, wherein the activity is gambling and the triggering condition is related to at least one of an amount wagered and/or an amount lost.

27. A system for changing the behavior of a user with respect to an activity, comprising:
a controller for automatically detecting performance of the activity by the user
a display operably connected to the controller, the controller for performing an interruption process, using the display, in response detecting the performance of the activity, the user not being allowed to perform the activity at least temporarily during the interruption process.

28. A system, as set forth in claim 27, the controller, in detecting performance of the activity, detects initiation of the activity by the user and detects occurrence of a predetermined triggering condition associated with performance of the predetermined activity.

29. A system, as set forth in claim 27, wherein the interruption process includes one or more queries with respect the activity.

30. A system, as set forth in claim 29, wherein the queries require input from the user in order to continue performance of the activity.

31. A system, as set forth in claim 27, wherein the controller, in performing an interruption process, displays a representation of a person performing an alternative behavior possibility on the display.

32. A system, as set forth in claim 31, wherein the alternative behavior possibility includes terminating the activity.

33. A system, as set forth in claim 31, wherein the representation of a person includes a likeness of the user.

34. A system, as set forth in claim 32, wherein the representation of a person performing an alternative behavior possibility includes the person walking away.

35. A system, as set forth in claim 27, wherein the activity is performed on a machine and the interruption process includes displaying one or more images and/or animations and/or movies on a display.

36. A system, as set forth in claim 35, wherein the display is associated with the machine.

37. A system, as set forth in claim 35, wherein the display is associated with a device remote from the machine.

38. A system, as set forth in claim 37, wherein the device remote from the machine is one of a cell phone, personal digital assistant or other suitable device.

39. A system, as set forth in claim 27, wherein the interruption process includes a predetermined time delay during which the user cannot perform the activity.

40. A system, as set forth in claim 27, wherein the activity is gambling and the interruption process includes one or more queries with respect to the user's desire or ability to continue gambling.

41. A system, as set forth in claim 40, the controller for establishing an amount lost and/or played by the user, providing the user with the amount lost and/or played, and asking the user whether they can afford to lose.

42. A system, as set forth in claim 40, wherein at least one query is related to an emotional state of the user.

43. A system, as set forth in claim 40, wherein at least one query asks the user if the user wants to continue.

44. A system, as set forth in claim 27, including a camera for capturing an image of the user using a camera, wherein the image is used in the interruption process.

45. A system, as set forth in claim 28, the controller for creating a user profile associated with the user, the triggering condition being defined by and/or based on the user profile.

46. A system, as set forth in claim 28, the controller for establishing a current location of the user, wherein the triggering condition is a function of the current location.

47. A system, as set forth in claim 28, wherein the triggering condition is time based.

48. A system, as set forth in claim 28, wherein the triggering condition is a time limit.

49. A system, as set forth in claim 48, wherein the time limit is established by the user.

50. A system, as set forth in claim 48, wherein the time limit is randomly determined.

51. A system, as set forth in claim 28, wherein the activity is the playing of a game, the triggering condition being related to a number of plays of the game.

52. A system, as set forth in claim 28, wherein the activity is gambling and the triggering condition is related to at least one of an amount wagered and/or an amount lost.

53. A method for changing the behavior of a user with respect to an activity, comprising:
automatically detecting performance of the activity by the user; and,
displaying, to the user, a representation of a person performing an alternative behavior possibility in response to detecting performance of the activity.

54. A method, as set forth in claim 53, wherein the step of detecting performance of the activity, includes the steps of:
detecting initiation of the activity by the user; and
detecting occurrence of a predetermined triggering condition associated with performance of the predetermined activity.

55. A method, as set forth in claim 53, including the steps of asking the user one or more queries with respect the activity.

56. A method, as set forth in claim 55, wherein the queries require input from the user in order to continue performance of the activity.

57. A method, as set forth in claim 53, wherein the alternative behavior possibility includes terminating the activity.

58. A method, as set forth in claim 53, wherein the representation of a person includes a likeness of the user.

59. A method, as set forth in claim 53, wherein the representation of a person performing an alternative behavior possibility includes the person walking away.

60. A method, as set forth in claim 53, wherein the activity is performed on a machine and the representation of a person performing an alternative behavior possibility is displayed on a display.

61. A method, as set forth in claim 60, wherein the display is associated with the machine.

62. A method, as set forth in claim 61, wherein the display is associated with a device remote from the machine.

63. A method, as set forth in claim 62, wherein the device remote from the machine is one of a cell phone, personal digital assistant, or other suitable device.

64. A method, as set forth in claim 53, wherein the activity is gambling, the method further including the step of asking the user one or more queries with respect to the user's desire or ability to continue gambling.

65. A method, as set forth in claim 64, including the step of establishing an amount lost and/or played by the user, providing the user with the amount lost and/or played, and asking the user whether they can afford to lose.

66. A method, as set forth in claim 64, wherein at least one query is related to an emotional state of the user.

67. A method, as set forth in claim 64, wherein at least one query asks the user if the user wants to continue.

68. A method, as set forth in claim 53, including the step of capturing an image of the user using a camera, wherein the image is used in the representation of a person performing an alternative behavior possibility.

69. A method, as set forth in claim 54, including the step of creating a user profile associated with the user, the triggering condition being defined by and/or based on the user profile.

70. A method, as set forth in claim 54, including the step of establishing a current location of the user, wherein the triggering condition is a function of the current location.

71. A method, as set forth in claim 54, wherein the triggering condition is time based.

72. A method, as set forth in claim 54, wherein the triggering condition is a time limit.

73. A method, as set forth in claim 72, wherein the time limit is established by the user.

74. A method, as set forth in claim 72, wherein the time limit is randomly determined.

75. A method, as set forth in claim 53, wherein the activity is the playing of a game, the triggering condition being related to a number of plays of the game.

76. A method, as set forth in claim 53, wherein the activity is gambling and the triggering condition is related to at least one of an amount wagered and/or an amount lost.

77. A system for changing the behavior of a user with respect to an activity, comprising:
a controller for automatically detecting performance of the activity by the user; and,
a display operably connected to the controller, the controller for displaying on the display a representation of a person performing an alternative behavior possibility on the display in response to detecting performance of the activity.

78. A system, as set forth in claim 77, wherein the controller in detecting performance of the activity, detects initiation of the activity by the user and detects occurrence of a predetermined triggering condition associated with performance of the predetermined activity.

79. A system, as set forth in claim 77, the controller for asking the user one or more queries with respect to the activity.

80. A system, as set forth in claim 79, wherein the queries require input from the user in order to continue performance of the activity.

81. A system, as set forth in claim 77, wherein the alternative behavior possibility includes terminating the activity.

82. A system, as set forth in claim 77, wherein the representation of a person includes a likeness of the user.

83. A system, as set forth in claim 77, wherein the representation of a person performing an alternative behavior possibility includes the person walking away.

84. A system, as set forth in claim 77, wherein the activity is performed on a machine and the representation of a person performing an alternative behavior possibility is displayed on the display.

85. A system, as set forth in claim 84, wherein the display is associated with the machine.

86. A system, as set forth in claim 84, wherein the display is associated with a device remote from the machine.

87. A system, as set forth in claim 86, wherein the device remote from the machine is one of a cell phone, personal digital assistant, or other suitable device.

88. A system, as set forth in claim 77, wherein the activity is gambling, the controller for asking the user one or more queries with respect to the user's desire or ability to continue gambling.

89. A system, as set forth in claim 88, the controller for establishing an amount lost and/or played by the user, providing the user with the amount lost and/or played, and asking the user whether they can afford to lose.

90. A system, as set forth in claim 88, wherein at least one query is related to an emotional state of the user.

91. A system, as set forth in claim 88, wherein at least one query asks the user if the user wants to continue.

92. A system, as set forth in claim 77, including a camera operably coupled to the controller for capturing an image of the user using a camera, wherein the image is used in the representation of a person performing an alternative behavior possibility.

93. A system, as set forth in claim 78, the controller for creating a user profile associated with the user, the triggering condition being defined by and/or based on the user profile.

94. A system, as set forth in claim 78, the controller for establishing a current location of the user, wherein the triggering condition is a function of the current location.

95. A system, as set forth in claim 78, wherein the triggering condition is time based.

96. A system, as set forth in claim 78, wherein the triggering condition is a time limit.

97. A system, as set forth in claim 98, wherein the time limit is established by the user.

98. A system, as set forth in claim 98, wherein the time limit is randomly determined.

99. A system, as set forth in claim 77, wherein the activity is the playing of a game, the triggering condition being related to a number of plays of the game.

100. A system, as set forth in claim 77, wherein the activity is gambling and the triggering condition is related to at least one of an amount wagered and/or an amount lost.
